(19) United States
(12) Patent Application Publication
(10) Pub. No.: US 2009/0033606 A1
(43) Pub. Date: Feb. 5, 2009

(54) LIQUID CRYSTAL DISPLAY APPARATUS AND METHOD OF DRIVING THE LIQUID CRYSTAL DISPLAY APPARATUS

(76) Inventors: Yukio TANAKA, Kanazawa-shi (JP); Kenji NAKAO, Kanazawa-shi (JP); Tetsuo FUKAMI, Ishikawa-gun (JP); Kazuhiro NISHIYAMA, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/183,393

(22) Filed: Jul. 31, 2008

(30) Foreign Application Priority Data
Aug. 2, 2007 (JP) 2007-202316

(51) Int. Cl. G09G 3/36

(52) U.S. Cl. 345/87

(57) ABSTRACT

A liquid crystal display includes pixels, driver circuits, and a control circuit. The control circuit sets, in a one-frame period, a first period and a second period shorter than the one-fame period and partly overlapping the first period. The control circuit controls the driver circuits, causing them to write non-video signals for the pixels in the first period, to write video signals for the driver circuits in the second period, and to write the non-video signals and the video signals alternately in units of one or more horizontal periods in a part of the first period, which overlaps the second period, and to output the non-video signals and the video signals alternately in units of one or more horizontal periods in a part of the first period, which does not overlap the second period, and to write the non-video signals in a period for writing non-video signals.

### CROSS-REFERENCE TO RELATED APPLICATIONS

This application is based upon and claims the benefit of priority from prior Japanese Patent Application No. 2007-202316, filed Aug. 2, 2007, the entire contents of which are incorporated herein by reference.

### BACKGROUND OF THE INVENTION

1. Field of the Invention

The present invention relates to a liquid crystal display apparatus and a method of driving the liquid crystal display apparatus. More particularly, the invention relates to a liquid crystal display apparatus of active matrix type and a method of driving the liquid crystal display apparatus.

2. Description of the Related Art

In recent years, liquid crystal panels have seen various uses. They are now used, in rapidly increasing numbers, in outdoor apparatuses such as automobiles (as, for example, car-navigation displays and rear-seat entertainment displays). If used in automobiles, the liquid crystal panels need to display images well even at an ultra-low temperature range of −30° C. to 0° C. As liquid crystal that is fit for operation at such ultra-low temperatures, optically compensated bend (OCB) liquid crystal is attracting much attention.

A liquid crystal display has been proposed, in which a high voltage is applied to the OCB liquid crystal for a specific time during each one-frame period, or at a specific time ratio, in order to prevent so-called reverse transition, i.e., transition from bend alignment to splay alignment, thereby to accomplish, for example, black-and-white display. (See, for example, Jpn. Pat. Apply. KOKAI Publication No. 2007-140066.) In this case, scanning (hereinafter referred to as black-insertion scanning) for writing a reverse-transition preventing signal (e.g., black signal) and scanning (hereinafter referred to as signal scanning) for writing a video signal are performed at least once in the one-frame period.

The inventors hereof have developed a specific method of driving a liquid crystal display in which black display is achieved at a specific time ratio during each one-frame period. In this method (hereinafter referred to as black-insertion driving method), a first period and a second period are set in each one-frame period, the latter overlapping the former. In the first period, the black-insertion scanning is performed. In the second period, the signal scanning is performed. For a period in which the first and second periods overlap each other, the black-insertion scanning and the signal scanning are alternately performed for one or more horizontal cycles.

If a liquid crystal display is driven by overlapping the black-insertion scanning and the signal scanning as described above, the time ratio at which to make each pixel achieve black display during a one-frame period can be set to any desired value and the backlight-on time can be increased to a maximum.

When a liquid crystal display undergoes such a black-insertion drive as described above, however, two almost horizontal lines may appear in the display screen if the entire display screen displays, for example, a uniform intermediate-tone image, as the inventors have confirmed in their experiments. The inventors studied this phenomenon, finding out that this phenomenon appear when the signal supplied to a signal is not controlled, in some cases, during that part of the first period, which does not overlap the second period.

### BRIEF SUMMARY OF THE INVENTION

The present invention has been made in view of the foregoing. An object of the invention is to provide a liquid crystal display apparatus that can display high-quality images, regardless of images displayed by them, and a method of driving this liquid crystal display apparatus.

A liquid crystal display apparatus according to a first embodiment of this invention comprises: a plurality of liquid crystal pixels arranged in a pattern like a matrix, a driver circuit configured to periodically write non-video signals and video signals, as pixel voltages, in the liquid crystal pixels, and a control circuit configured to control an operation timing of the driver circuit. The control circuit controls sets, in each one-frame period, a first period and a second period partly overlapping the first period, controls the driver circuit, causing the driver circuit to write non-video signals for the liquid crystal pixels in the first period, to write video signals for the liquid crystal pixels in the second period, and to write non-video signals and video signals alternately in units of one or more horizontal cycles in a part of the first period, which overlaps the second period. The control circuit controls the driver circuit, causing the driver circuit to output non-video signals and video signals alternately in units of one or more horizontal cycles in a part of the first period, which does not overlap the second period, and to write non-video signals in the liquid crystal pixels, while the non-video signals are being output.

A method of driving a liquid crystal display apparatus, according to a second embodiment of this invention, is designed to control a liquid crystal display apparatus that comprises a plurality of liquid crystal pixels, a driver circuit and illumination means. The method comprises: setting, in a one-frame period, a first period and a second period partly overlapping the first period; causing the driver circuit to write non-video signals for the liquid crystal pixels in the first period; causing the driver circuit to write video signals for the liquid crystal pixels in the second period; causing the driver circuit to write non-video signals and video signals alternately in units of one or more horizontal cycles in a part of the first period, which overlaps the second period; controlling the driver circuit, causing the driver circuit to write the non-video signals and the video signals alternately in units of one or more horizontal cycles in a part of the first period, which overlaps the second period; and controlling the driver circuit, causing the driver circuit to output non-video signals and video signals alternately in units of one or more horizontal cycles in a part of the first period, which does not overlap the second period, and to write non-video signals, in a period of writing non-video signals.

The present invention can provide a liquid crystal display apparatus that can display high-quality images, regardless of images displayed by them, and a method of driving this liquid crystal display apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display device according to a first embodiment of the present invention;

FIG. 2 is a view for describing an example of a method of driving the liquid crystal display shown in FIG. 1;

FIG. 3 is a view for describing another example of the method of driving the liquid crystal display shown in FIG. 1;

FIG. 4 is a view for describing a different method of driving the liquid crystal display shown in FIG. 1;

FIG. 5 is a view for describing an image a liquid crystal display displays when it is driven by the conventional method;

FIG. 6 is a view for describing why such an image as shown in FIG. 5 is displayed; and

FIG. 7 is a view for describing another method of driving the liquid crystal display shown in FIG. 1.

### DETAILED DESCRIPTION OF THE INVENTION

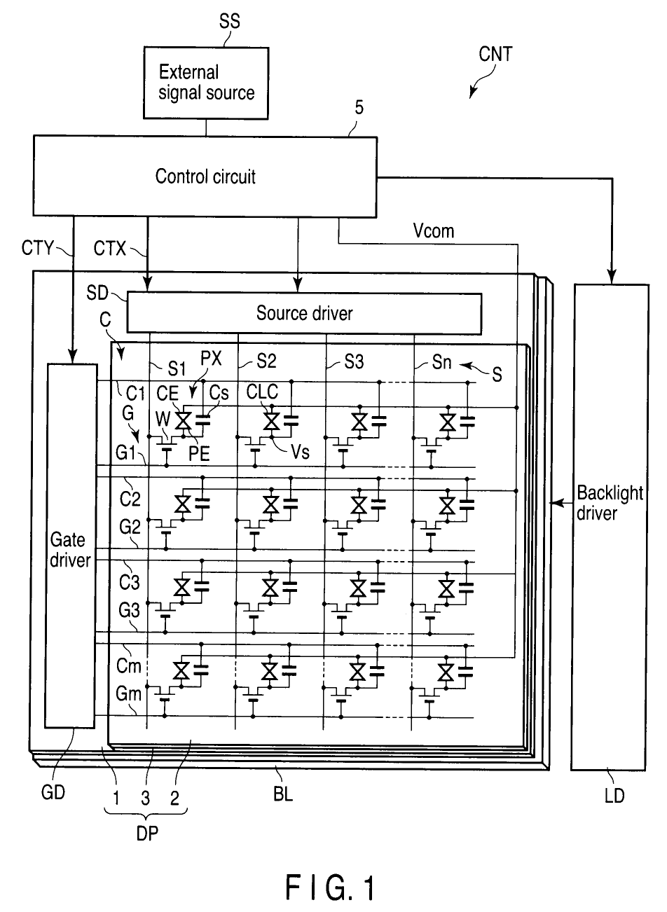

A liquid crystal display according to an embodiment of the present invention will be described with reference to the accompanying drawings. As shown FIG. 1, the liquid crystal display according to the embodiment has a liquid crystal display panel DP of OCB mode, a backlight BL, as an illumination means, designed to illuminate the liquid crystal display panel DP, and a control circuit unit CNT configured to control the liquid crystal display panel DP and backlight BL.

The liquid crystal display panel DP has a pair of substrates, i.e., array substrate 1 and countersubstrate 2, and a liquid crystal layer 3 interposed between the array substrate 1 and the countersubstrate 2. The liquid crystal layer 3 contains, as liquid crystal material, OCB-mode liquid crystal whose alignment changes from splay alignment to bend alignment to perform, for example, a normally-white display operation. In the embodiment, the reverse transition of alignment, i.e., from bend alignment to splay alignment, is prevented by periodically applying a high voltage as a non-video signal, to the liquid crystal layer 3. The high voltage is, for example, a drive voltage (hereinafter called black-insertion voltage) for achieving black display.

In addition, the liquid crystal display panel DP includes a display section which is composed of display pixels PX that are arrayed substantially in a matrix. The display pixels PX are illuminated by backlight BL. The array substrate 1 includes a transparent insulating substrate which is formed of, e.g. glass. A plurality of pixel electrodes PE are disposed in association with the respective display pixels PX on the transparent insulating substrate.

The countersubstrate 2 includes a color filter (not shown) which is formed of red, green and blue color layers disposed on a transparent insulating substrate of, e.g. glass, and a counterelectrode CE which is disposed on the color filter and is opposed to the plural pixel electrodes PE.

The pixel electrodes PE and the counterelectrode CE are made of transparent electrode material, for example, such as ITO (Indium Tin Oxide). The pixel electrodes PE and counterelectrode CE are covered with alignment films (not shown), respectively, which are subjected to rubbing treatment in a mutually parallel direction. Each pixel electrode PE and counterelectrode CE, together with a pixel region which is a part of the liquid crystal layer 3 that is controlled to have a liquid crystal molecular alignment corresponding to an electric field from the pixel electrode PE and counterelectrode CE, constitute the display pixel PX.

Each of the display pixels PX has a liquid crystal capacitance Clc which is constituted by the liquid crystal layer 3 that is held between the associated pixel electrode PE and counter-electrode CE. The liquid crystal capacitance Clc is determined by a specific dielectric constant of liquid crystal material, a pixel electrode area, and a liquid crystal cell gap. In addition, a storage capacitance Cs is constituted by a part of the pixel electrode PE and a part of a storage capacitance line C extending substantially in parallel to a scanning line G, which are stacked via an insulation film so as to be opposed to each other.

Further, the array substrate 1 includes a plurality of scanning lines G (G1 to Gm) which are disposed along rows of the pixel electrodes PE, a plurality of signal lines S (S1 to Sn) which are disposed along columns of the pixel electrodes PE, and a plurality of pixel switches W which are disposed near intersections between the scanning lines G and signal lines S.

Each pixel switch W is composed of, e.g. a thin-film transistor. The pixel switch W has a gate electrode connected to the scanning line G, and a source-drain path connected between the signal line S and the pixel electrode PE. Each pixel switch W permits, when driven via the associated scanning lines G, electrical conduction between the associated signal lines S and the associated pixel electrodes PE.

The controller CNT includes a gate driver GD which successively drives the scanning lines G1 to Gm so as to turn on the plural pixel switches W on a row-by-row basis; a source driver SD which outputs video signals or non-video signals to the plural signal lines S1 to Sn during a time period in which the pixel switches W of each row are turned on by the driving of the associated scanning line G; a backlight driving unit (inverter) LD which drives the backlight BL; and a control circuit 5 which controls the gate driver GD, source driver SD and backlight driving unit LD.

The control circuit 5 is configured to execute an initializing process for transitioning liquid crystal molecules from splay alignment to bend alignment by varying a countervoltage Vcom at a time of power-on and applying a relatively high driving voltage to the liquid crystal layer 3.

The control circuit 5 outputs to the gate driver GD a control signal CTG which is generated on the basis of a sync signal that is input from an external signal source SS. The control circuit 5 outputs to the source driver SD a control signal CTS which is generated on the basis of the sync signal that is input from the external signal source SS, and a video signal or a reverse-transition prevention voltage for black insertion, which is input from the external signal source SS. Further, the control circuit 5 outputs a countervoltage Vcom, which is to be applied to the counterelectrode CE, to the counterelectrode CE of the counter-substrate 2.

As described above, the source driver SD drives the plural signal lines S1 to Sn in parallel. The voltage (hereinafter referred to as “source voltage”) that is applied to the signal line, S1 to Sn, is applied via the associated pixel switch W to the pixel electrode PE of the liquid crystal pixel PX of the selected row. The potential difference between the source voltage applied to the pixel electrodes PE and the countervoltage Vcom applied to the counterelectrode CE is held in the liquid crystal capacitor CIc. The source voltages for all liquid crystal pixels PX are set at opposite polarities on a column-by-column basis of liquid crystal pixels PX in the case of a column-reversal driving method, and set at opposite polarities on a frame-by-frame basis in the case of a frame-reversal driving method.

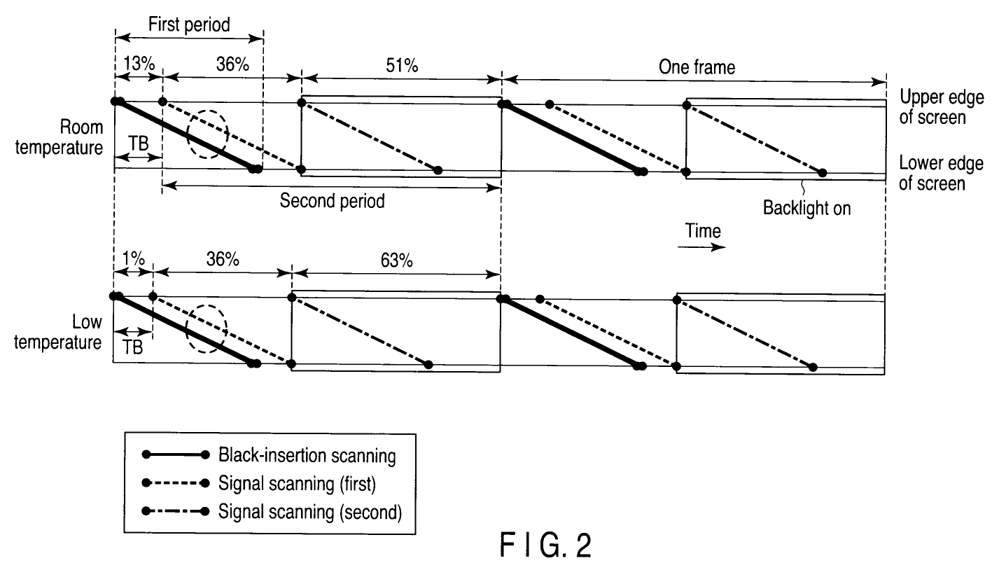

FIG. 2 shows a scan timing applied in a method of driving the liquid crystal display according to the present embodiment. In FIG. 2, time is plotted on the abscissa, and position in the perpendicular to the plane of drawing is plotted on the ordinate. Thus, FIG. 2 represents the gate-scan timing in the liquid crystal display panel DP.

In the liquid crystal display according to this embodiment, so-called black-insertion driving is performed, in which black display is effected during each one-frame period, at a specific time ratio, in order to prevent so-called reverse transition, i.e., alignment transition of OCB liquid crystal from bend alignment to splay alignment. To perform the black-insertion driving, scanning (black-insertion scanning) for writing a black signal and scanning (signal scanning) for writing a video signal must be performed at least once in the one-frame period.

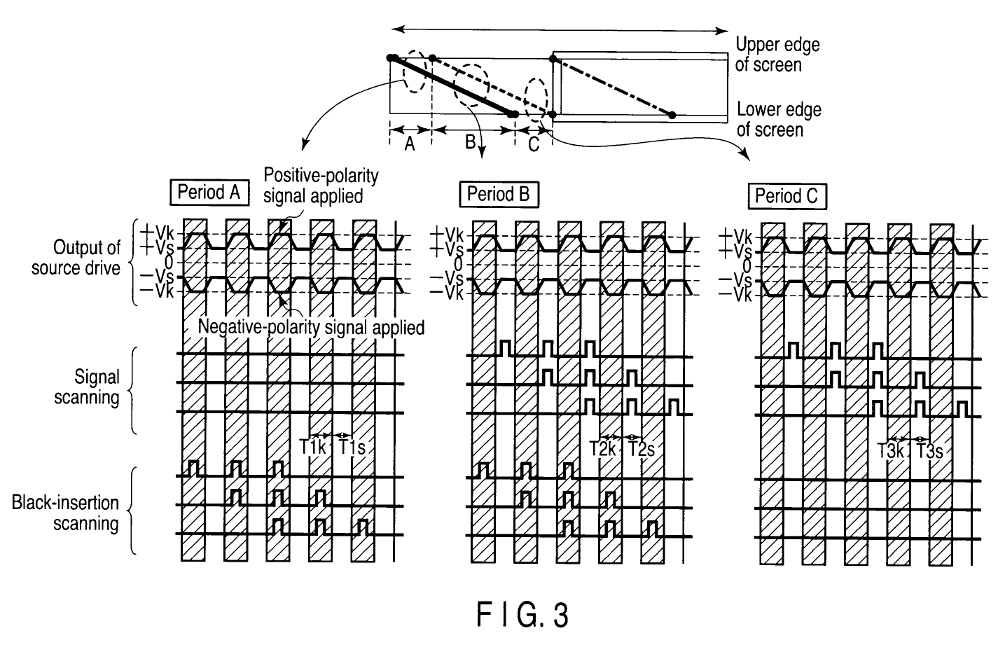

As shown in FIGS. 2 and 3, in the liquid crystal display according to this embodiment, the black-insertion scanning performed once and the signal scanning are performed twice, respectively, in the one-frame period. FIG. 3 shows the output signals of the source driver SD, some of which are positive in polarity and the others of which are negative in polarity, with respect to the reference voltage. The positive-polarity signals and the negative-polarity signals are alternately supplied in one-frame periods. In the column-reverse driving, the positive-polarity signals and the negative-polarity signals are alternately supplied to the rows of signal lines S. In FIG. 3, ±Vk indicates the black-insertion voltage output from the source driver SD, and ±Vs indicates the video-signal voltage.

As seen from FIG. 3, a first period and a second period for black-insertion scanning and signal scanning, respectively, are set in the one-frame period. The first period (periods A and B, FIG. 3) is shorter than the one-frame period. The second period (periods B and C, FIG. 3) overlaps the first period and shorter than the one-frame period. The control circuit 5 controls the source driver SD and the gate driver GD, causing them to perform the black-insertion scanning in the first period and the signal scanning in the second period for the first time.

In the liquid crystal display according to this embodiment, the control circuit 5 controls the source driver SD and the gate driver GD, causing them to perform auxiliary signal scanning, or the signal scanning for the second time, after performing signal scanning for the first time.

Now that signal scanning has been performed for the second time, signals can be reliably written in the pixels PX, even if the time for writing is not enough when the signal scanning was performed for the first time. Thus, undesirable outcome, such as decrease in luminance that would otherwise occur, can be avoided.

The control circuit 5 controls the source driver SD and the gate driver GD, causing them to perform the black-insertion scanning and the signal scanning alternately in units of one or more horizontal cycles (i.e., period T2k or T2s, FIG. 3) as shown in FIG. 3, in period B for which the first and second periods overlaps each other in the one-frame period.

Moreover, the control circuit 5 controls the source driver SD and the gate driver GD, causing the source driver SD to output non-video signals and video signals alternately in units of one or more horizontal cycles (i.e., periods T1k and T1s, FIG. 3) in period A preceding period B included in the first period of the one-frame period and not overlapping the second period, just in the same way as in period B, and to write non-video signals in the horizontal period T1k included in period A.

Thus, for period A, too, the source driver SD outputs video signals and non-video signals alternately. The gate driver GD drives the scanning lines G, one after another, in synchronization with a timing of which the video signals are supplied to the signal lines S. The liquid crystal display according to this embodiment, which is shown in FIG. 3, is so driven that the source driver SD outputs intermediate-level (gray-level) signals, i.e., signals representing colors between white and black, for period T1s that corresponds to the signal-scanning part of period A. In this embodiment, the signals that the source driver SD outputs for period T1s is at a fixed voltage that corresponds to an intermediate level. These signals need not be set at a fixed voltage, nevertheless. The signal voltage can vary a little.

For the one-frame period, the source driver SD and the gate driver GD are so controlled that the source driver SD outputs non-video signals and video signals alternately in period C following period B and not overlapping the first period, as in period B, in units of either one or more horizontal cycles (i.e., periods T3k and T3s shown in FIG. 3), and that the source driver SD writes video signals for period T3s corresponding to a signal-scanning period.

Thus, the source driver SD outputs video signals and non-video signals (i.e., black-insertion signals) alternately in period C. The gate driver GD drives the scanning lines G one after another, in synchronization with a timing of which video signals are supplied to the signal lines S.

The horizontal cycles shown in FIG. 3 (e.g., periods T1k and T1s) are long enough to write a non-video signal or video signal, for achieving black insertion, to one liquid crystal pixel PX. The horizontal cycle is the same for both the black-insertion writing and the video-signal writing in the present embodiment. Nonetheless, the horizontal cycle need not be the same for the black-insertion writing and the video-signal writing, according to the present invention.

In the liquid crystal display according to this embodiment, the backlight BL is made to blink in synchronization with a timing of which the liquid crystal display panel DP is driven. More specifically, the backlight BL blinks for a period between, for example, the completion of the write scanning and the next black-insertion scanning. Since the backlight is so controlled, the light the backlight BL emits would not leak to decrease the contrast. For the same reason, the visibility of moving pictures can be as high as with CRTs. Furthermore, the power-use efficiency of the backlight BL can be enhanced because the backlight BL is off while the liquid crystal remains in the black-insertion state.

The control circuit 5 controls the backlight BL, turning off backlight BL for at least the first period. In the liquid crystal display according to this embodiment, as shown in FIG. 2, the backlight BL is turned on at the time the first signal scanning is completed is turned off at the time the black-insertion canning is started for the next frame. The blinking of the backlight BL is delayed somewhat, in consideration of the response delay of the liquid crystal. That is, the back light BL is turned on some time after, for example, the completion of the first signal scanning.

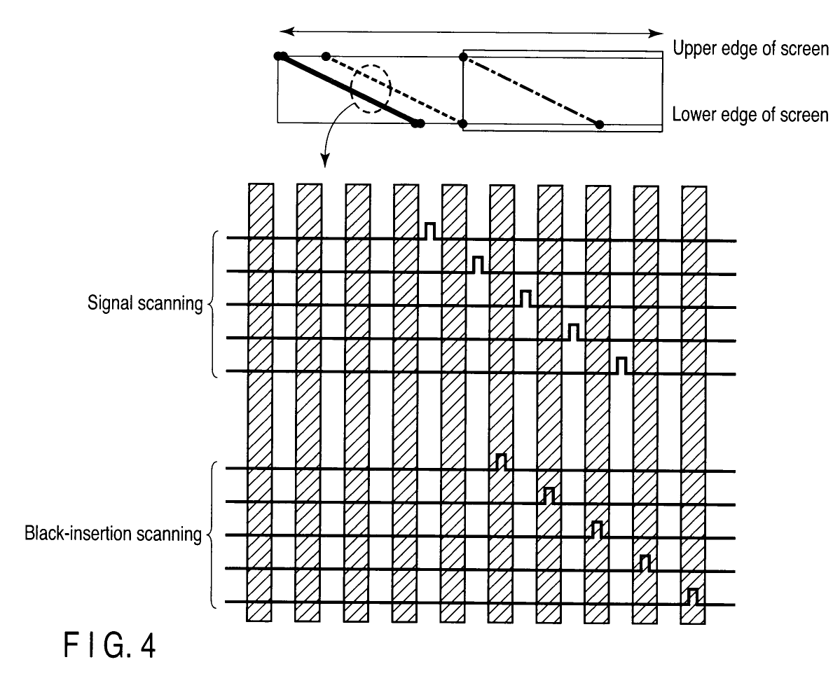

In the case shown in FIG. 3, the black-insertion scanning and the signal scanning are performed by driving each gate line several times, thereby accomplishing writing, for example, three times. Nonetheless, as FIG. 4 shows, either scanning may be performed by driving the gate line only once. Note that FIG. 3 shows the case where both the black-insertion scanning and the signal scanning are performed by driving each gate line three times. Since each scanning line G is driven several times to perform writing several times, the liquid crystal display can be improved in terms of writing characteristic. Hence, a decrease in luminance caused by not enough writing can be avoided, which would otherwise occur.

In the conventional liquid crystal display, the source driver SD outputs a black-insertion signal ±Vk in period T1 corresponding to the black-insertion scanning performed in period A of the first period, which does not overlap the second period. In period T1s corresponding to the signal scanning performed in period A, however, the source driver SD outputs an indefinite signal not controlled at all. In period B where the first and second periods overlap each other, the source driver SD outputs black-insertion signals ±Vk and video signals ±Vs alternately.

In the conventional liquid crystal display, the source driver SD outputs an indefinite signal not controlled at all, in period T3k corresponding to period C of the second period, which does not overlap the first period. In period T3s corresponding to the signal canning performed in period C, the source driver SD outputs a video signal.

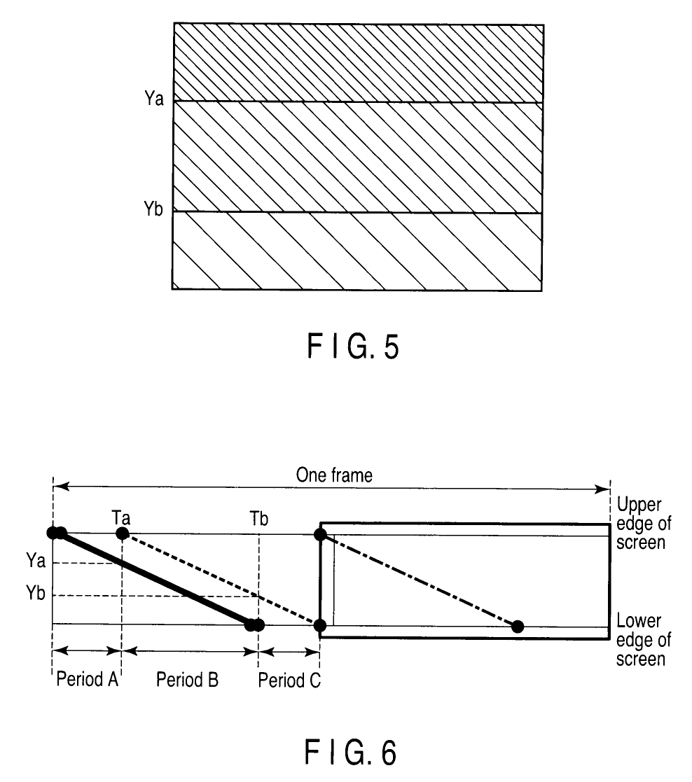

At this point, two horizontal lines may appear in the display screen as shown in FIG. 5, for example, if the entire display screen displays a uniform intermediate-tone image, and the regions of the screen, demarcated in vertical direction by these horizontal lines, may differ in luminance. If length of period A of the first period, which does not overlap the second period, is changed, the two horizontal lines will be moved upwards and downwards corresponding to the length of period A, respectively.

The positions Ya and Yb the two horizontal lines shown in FIG. 5 assume in the vertical direction, respectively, correspond to the vertical positions Ya and Yb illustrated in the timing chart of FIG. 6. In other words, as shown FIG. 6, of two horizontal lines shown in FIG. 5, one corresponds to the vertical position Ya where the black-insertion scanning corresponding to the first period is performed at timing Ta when the second period starts, and the other corresponds to the vertical position Yb where the signal scanning corresponding to the second period is performed at timing Tb when the first period ends.

As seen from FIG. 6, black-insertion scanning and the signal scanning are alternately performed for period B, or from timing Ta to timing Tb, in each horizontal cycle. In period T2k of period B corresponding to the black-insertion scanning, the output of the source driver SD changes to a black-insertion output from the video signal output in period T2s that corresponds to the immediately preceding signal scanning. As the output of the source driver SD so changes, electric potentials of the signal lines provided in the liquid crystal display panel DP are charged, from the video-signal voltage to the black-insertion voltage.

On the other hand, in period T2s of period B corresponding to the signal scanning, the output of the source driver SD changes to a video signal from the black-insertion signal output in period T2k that corresponds to the immediately preceding black-insertion scanning. As the output of the source driver SD so changes, electric potentials of the signal lines provided in the liquid crystal display panel DP are charged from the black-insertion voltage to the video-signal voltage.

The signal lines S should be so charged completely in the initial part of each horizontal cycle. It is basically desirable to set the source-drain paths of the pixel switches W to conducting state after charging the signal lines, thereby to charge the pixels PX through the signal lines S. If the throughput of the source driver SD is insufficient or the time constant of the signal lines S are too large, however, the source-drain paths of the pixel switches W may become conducting before the signal lines S are completely charged. In this case, the signal-line potential will inevitably be applied from the signal lines S to the pixel electrodes PE.

Consequently, the potential to which the pixels PX are charged is influenced not only by the outputs the source driver SD generates in the horizontal cycle, but also by the outputs the source driver SD generates in the preceding horizontal cycle. The outputs the source driver SD generates in the preceding horizontal cycle are the signals output from the source driver SD in the period corresponding to the immediately preceding black-insertion scanning in the case of the signal scanning, and the signals output from the source driver SD in the period corresponding to the immediately preceding signal scanning in the case of the black-insertion scanning.

In period A that lasts from the beginning of the one-frame cycle to timing Ta, for example, only the black-insertion scanning is performed. That is, the source-drain paths of the pixel switches W are conducting, only for period T1k corresponding to the black-insertion scanning. Any pixel switch W remains off for period T1s that corresponds to the signal scanning.

In period T1k corresponding to the black-insertion scanning, the source driver SD outputs a black-insertion signal. In period T1s corresponding to the signal scanning, the source driver SD outputs an indefinite signal not designated in particular. If the throughput of the source driver SD is insufficient or the time constant of the signal lines S are too large, the potential written in the pixels PX in period T1k corresponding to the black-insertion scanning will be influenced by not only by the black-insertion signals output from the source driver SD in period Tk1 corresponding to the black-insertion scanning, but also by the indefinite signal not controlled at all and output from the source driver SD in period T1s corresponding to the immediately preceding signal scanning.

In period C that lasts from timing Tb in the one-frame cycle to the completion of the first signal scanning, only the signal scanning is performed. That is, the source-drain paths of the pixel switches W are conducting, only for period T3s corresponding to the signal scanning. Any pixel switch W remains off for period T3k that corresponds to the signal scanning.

In period T3s corresponding to the signal scanning, the source driver SD outputs a video signal. In period T3k corresponding to the black-insertion scanning, the source driver SD outputs an indefinite signal not designated in particular. If the throughput of the source driver SD is insufficient or the time constant of the signal lines S are too large, the potential written in the pixels PX in period T3s corresponding to the signal scanning will be influenced by not only by the video signal output from the source driver SD in period T3s corresponding to the signal scanning, but also by the indefinite signal not controlled at all and output from the source driver SD in period T3k corresponding to the immediately preceding black-insertion scanning.

As has been described, in the conventional liquid crystal display, two signals change discontinuously, which the source driver SD outputs when periods A and B are switched at timing Ta, respectively in periods T1s and T2s that correspond to the signal scanning for period A and the signal scanning for period B. In this case, the potentials written in the liquid crystal pixel PX during periods T1k and T2k that correspond to the black-insertion scanning may therefore change due to the discontinuous change of two signals, too. As a result, as the inventors have found, a horizontal line appears at the vertical position Ya on the screen, which corresponds to timing Ta, due to the discontinuous change of luminance.

Similarly, two signals change discontinuously, which the source driver SD outputs when periods B and C are switched at timing Tb, respectively in periods T2s and T3s that correspond to the signal scanning for period A and the signal scanning for period B. In this case, the potentials written in the liquid crystal pixel PX during periods T2s and T3s that correspond to the black-insertion scanning may therefore change due to the discontinuous change of two signals, too. As a result, as the inventors have found, a horizontal line appears at the vertical position Yb on the screen, which corresponds to timing Tb, due to the discontinuous change of luminance.

By contrast, in the liquid crystal display according to this embodiment, the source driver SD outputs an intermediate-level signal in period T1s corresponding to the signal scanning, as shown in FIG. 3, during period A of the first period, which does not overlap the second period. Since the liquid crystal display is so driven, two signals do not discontinuously change, which the source driver SD outputs when periods A and B are switched at timing Ta, respectively in periods T1s and T2s that correspond to the signal scanning for period A and the signal scanning for period B. Therefore, such a horizontal line as shown in FIG. 5 will not appear at the vertical position Ya on the screen.

Further, in the liquid crystal display according to this embodiment, the source driver SD outputs a black-insertion signal in period T3k corresponding to the black-insertion scanning during period C of the second period, which does not overlap the first period. Since the liquid crystal display is so driven, two signals do not discontinuously change, which the source driver SD outputs when periods B and C are switched at timing Tb, respectively in periods T2k and T3k that correspond to the black-insertion scanning for period B and the signal scanning for period D. Therefore, such a horizontal line as shown in FIG. 5 will not appear at the vertical position Yb on the screen.

Thus, the present invention can provide a liquid crystal display apparatus that can display high-quality images, regardless of images displayed by them, and a method of driving this liquid crystal display apparatus.

The present invention is not limited to the embodiment described above. The components of the embodiment can be modified in various manners in reducing the invention to practice, without departing from the sprit or scope of the invention.

For example, in period A, the source driver SD may output a signal that corresponds to an average gradation level calculated for all video signals representing an image to display on the entire screen in the one-frame period, not outputting intermediate-level (gray-level) signals for period T1s that corresponds to signal scanning. Alternatively, the source driver SD may output video signals output in period T2s corresponding to the first signal scanning performed in period B, i.e., the video signals to be written in period B into the liquid crystal pixels PX defining the upper edge of the screen. In this case, the signals to supply to the rows of signal lines S may be set in accordance with the video signals the source driver SD outputs in period T2s corresponding to the first signal scanning performed in period B. For example, the signal that the source driver SD outputs to the signal lien S1 in period T1s corresponding to the signal scanning performed in period A is a video signal that the source driver SD outputs to the signal lien S1 in period T2s corresponding to the first signal scanning performed in period B.

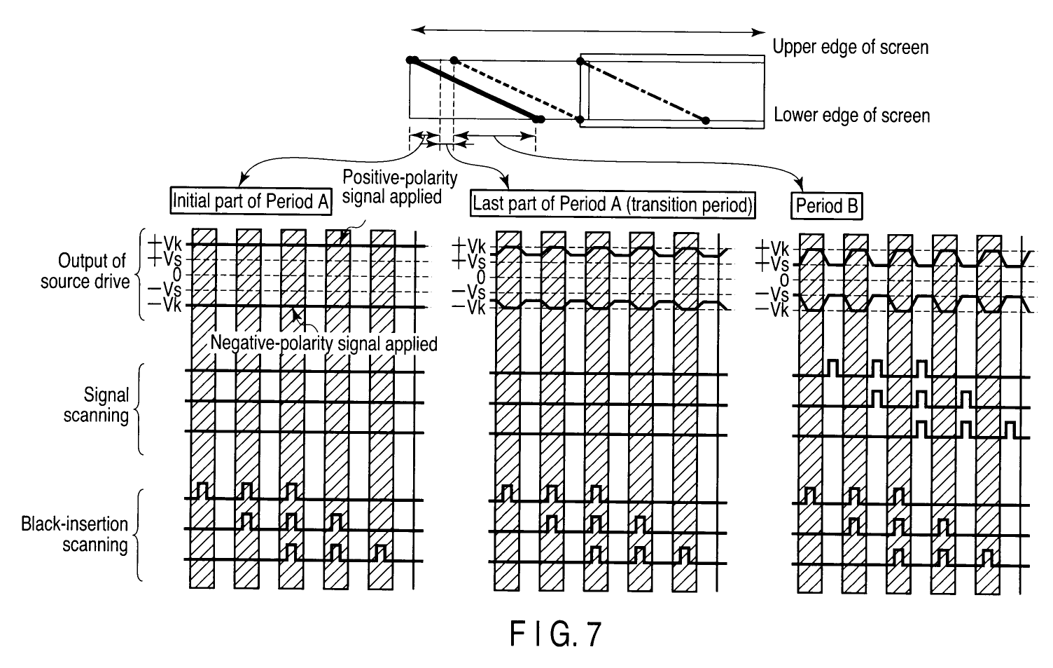

Alternatively, as shown in FIG. 7, signals of intermediate-level, e.g., gray-level, may be output in period T1s that corresponds to the first signal scanning in period A. And video signals to output from the source driver SD in period T2s corresponding to the first signal scanning performed in period B, i.e., video signals to be written into the liquid crystal pixels PX defining the upper edge of the screen, may be output in period T1s that corresponds to the last signal scanning in period A.

In the period between period T1s corresponding to the first signal scanning in period A and period T1s corresponding to the last signal scanning in period A, the output the source driver generates in period T1s corresponding the signal scanning may be gradually changed to approach the signal output in period T2s corresponding to the first signal scanning performed in period B. If the liquid crystal display is driven as shown in FIG. 7, the signals output from the source driver will change, neither greatly nor discontinuously.

Since the liquid crystal display is so driven, the signals the source driver SD outputs in periods T1s and T2s, both corresponding to the signal scanning, are prevented from changing discontinuously at timing Ta when periods A and B are switched. As a result, the image displayed on the screen would not undergo discontinuous changes. The same advantages can therefore be attained as in the embodiment described above.

Still alternatively, timing Ta at which periods A and B are switched and timing Tb at which periods B and C are switched for one or more frames may be shifted, thereby to move the vertical positions Ya and Yb (shown in FIG. 5) for one or more frames. Once the vertical positions Ya and Yb have been so moved, the two horizontal lines are hardly conspicuous. Thus, the discontinuous change in the image displayed on the screen will be prevented from being conspicuous, if timing Ta and timing Tb in the one-frame period are changed for one or more frames. The same advantages can therefore be attained as in the embodiment described above.

Further, the components of the embodiment described above may be combined in various ways, thereby to make different inventions. For example, some of the component used in the embodiment may not be used. Moreover, the components of the different embodiments may be combined in any desired fashion.

What is claimed is:

1. A liquid crystal display apparatus comprising a plurality of liquid crystal pixels which are arrayed substantially in a matrix, a driver circuit configured to periodically write non-video signals and video signals, as pixel voltages, in the liquid crystal pixels, and a control circuit configured to control an operation timing of the driver circuit,
wherein the control circuit controls sets, in each one-frame period, a first period and a second period partly overlapping the first period, controls the driver circuit, causing the driver circuit to write non-video signals for the liquid crystal pixels in the first period, to write video signals for the liquid crystal pixels in the second period, and to write non-video signals and video signals alternately in units of one or more horizontal cycles in a part of the first period, which overlaps the second period, and
the control circuit controls the driver circuit, causing the driver circuit to output non-video signals and video signals alternately in units of one or more horizontal cycles in a part of the first period, which does not overlap the second period, and to write non-video signals in the liquid crystal pixels, while the non-video signals are being output.

2. A liquid crystal display apparatus comprising a plurality of liquid crystal pixels which are arrayed substantially in a matrix, a driver circuit configured to periodically write non-video signals and video signals, as pixel voltages, in the liquid crystal pixels, and a control circuit configured to control an operation timing of the driver circuit,
wherein the control circuit is configured to set, in each one-frame period, a first period and a second period partly overlapping the first period, to control the driver circuit, causing the driver circuit to write non-video signals for the liquid crystal pixels in the first period, to write video signals for the liquid crystal pixels in the second period, and to write non-video signals and video signals alternately in units of one or more horizontal cycles in a part of the first period, which overlaps the second period, and
the control circuit is configured to control the driver circuit, causing the driver circuit to output non-video signals and video signals alternately in units of one or more horizontal cycles in a part of the second period, which does not overlap the first period, and to write specific video signals in a period of writing video signals.

3. The liquid crystal display apparatus according to claim 1 or 2, which further comprises illumination means for illuminating the liquid crystal pixels, and in which the control circuit controls the illumination means, turning off the illumination means for at least the first period.

4. The liquid crystal display apparatus according to claim 1 or 2, wherein the control circuit controls the drive circuit, causing the drive circuit to write the non-video signals for the liquid crystal pixels over a plurality of horizontal cycles.

5. The liquid crystal display apparatus according to claim 1 or 2, wherein the control circuit controls the drive circuit, causing the drive circuit to write the video signals for the liquid crystal pixels over a plurality of horizontal cycles.

6. The liquid crystal display apparatus according to claim 1 or 2, wherein the control circuit controls the drive circuit, causing the drive circuit to write, in the second period, second video signals after writing the video signals.

7. The liquid crystal display apparatus according to claim 1 or 2, further comprising a pair of substrates and a liquid crystal layer, the liquid crystal layer being interposed between the substrates of the pair and made of liquid crystal of the OCB mode.

8. A method of driving a liquid crystal display apparatus comprising a plurality of liquid crystal pixels, a driver circuit and illumination means, the method comprising:
setting, in a one-frame period, a first period and a second period partly overlapping the first period,
causing the driver circuit to write non-video signals for the liquid crystal pixels in the first period;
causing the driver circuit to write video signals for the liquid crystal pixels in the second period;
causing the driver circuit to write non-video signals and video signals alternately in units of one or more horizontal cycles in a part of the first period, which overlaps the second period;
controlling the driver circuit, causing the driver circuit to write the non-video signals and the video signals alternately in units of one or more horizontal cycles in a part of the first period, which overlaps the second period; and
controlling the driver circuit, causing the driver circuit to output non-video signals and video signals alternately in units of one or more horizontal cycles in a part of the first period, which does not overlap the second period, and to write non-video signals, in a period of writing non-video signals.

9. A method of driving a liquid crystal display apparatus comprising a plurality of liquid crystal pixels, a driver circuit and illumination means, the method comprising:
setting, in a one-frame period, a first period and a second period partly overlapping the first period,
causing the driver circuit to write non-video signals for the liquid crystal pixels in the first period;
causing the driver circuit to write video signals for the liquid crystal pixels in the second period;
controlling the driver circuit, causing the driver circuit to write the non-video signals and the video signals alternately in units of one or more horizontal cycles in a part of the first period, which overlaps the second period; and
controlling the driver circuit, causing the driver circuit to output non-video signals and video signals alternately in units of one or more horizontal cycles in a part of the second period, which does not overlap the first period, and to write specific video signals in a period of writing video signals.

10. The method according to claim 8 or 9, wherein the liquid crystal display further includes illumination means for illuminating the liquid crystal pixels, and the illumination means is controlled to be turned off for at least the first period.

11. The method according to claim 8 or 9, wherein the drive circuit is controlled to write the non-video signals for the liquid crystal pixels over a plurality of horizontal cycles.

12. The method according to claim 8 or 9, wherein the driver circuit is controlled to write the video signals for the liquid crystal pixels over a plurality of horizontal cycles.

13. The method according to claim 8 or 9, wherein the driver circuit is controlled to write, in the second period, second video signals after writing the video signals.
